(19) United States
(12) Patent Application Publication
(10) Pub. No.: US 2022/0415135 A1
(43) Pub. Date: Dec. 29, 2022

(54) BROWSER EXTENSION FOR USER INPUT ON STREAMING MEDIA

(71) Applicant: EBET, INC., Las Vegas, NV (US)

(72) Inventors: George Dixon, Dublin (IE); Bart Barden, Dublin (IE)

(21) Appl. No.: 17/847,575

(22) Filed: Jun. 23, 2022

Related U.S. Application Data
(63) Continuation of application No. 63/213,870, filed on Jun. 23, 2021.

(51) Int. Cl. G07F 17/32; G06Q 50/34

(52) U.S. Cl. CPC G07F 17/3288; G07F 17/323; G07F 17/3211; G06Q 50/34

(57) ABSTRACT

A system, method and computer program product for enabling and capturing, in real-time, user input related to betting on streaming of electronic sports being played on a streaming media module of a browser-based streaming platform running on a client computer. A system includes a betting extension module integrated with a browser that runs on the client computer, the betting extension module being configured to provide an interactive betting user interface that is synchronized with the streaming of the electronic sports. The interactive betting user interface provides user interactive interfaces for a user to provide the user input related to the electronic sports, for transmission to a betting processing platform via a network.

### CROSS-REFERENCES TO RELATED APPLICATIONS

The present application claims priority of U.S. Provisional Application No. 63/213,870, filed Jun. 23, 2021, and entitled “BROWSER EXTENSION FOR USER INPUT ON STREAMING MEDIA”, the entirety of which is incorporated by reference herein.

### TECHNICAL FIELD

The subject matter described herein relates to providing real-time viewer input to live-streamed electronic games, and more particularly to an online platform that provides a streamlined way to execute gaming, such as betting, on an electronic sports market, i.e. betting on an activity that is conducted via livestreamed video to a number of video terminals that are interconnected via a network.

### BACKGROUND

Sports betting is a form of gambling that involves predicting results of a sport activity or game, and placing a bet or wager on the outcome of that activity or game. For instance, bettors can place a bet as to which of two competing teams will prevail in a match or game, such as a soccer match or football game. In some cases, sports betting can occur at a more granular level, such as betting on the outcome of a single action, such as a single play of a football game, or whether a score of a soccer match will change over a short term of minutes. Sports betting can occur legally, such as through an official bookmaker, or illegally through private groups or entities. Betting on sport events and other competitions has occurred for as long as there has been competition.

More recently, however, there has been a rise in popularity of so-called electronic sports, otherwise known as “esports,” in which competition or activities occur in the context of a video game or online streaming digital media, and is observed and followed by fans solely through that domain or venue, referred to herein as a “streaming platform.” Esports are typically conducted as a multiplayer video game, where players can be individual players or a collection of players in a team.

Early participants in esports were usually amateur players, and spectators were typically limited to the players themselves or friends in close proximity to a player's computer or gaming display. However, with the growing use of real-time, browser-based streaming platforms such as YouTube® or Twitch®, which are particularly suited for real-time streaming of multiplayer video game content, spectatorship of esports games and activities has grown exponentially, and players are often professional and monetarily compensated.

Several websites for esports betting have recently been introduced, such as Gogawi.com by Esports Technologies Inc. These websites, while featuring rich content and information about a corresponding esports event to allow a fan to place bets on the event, are still separate and apart from the main streaming platform used by the esports event to stream the event. Accordingly, the betting experience through such websites requires a user to divert their attention from the streaming platform to such website to place a bet or monitor their outcomes, and includes many extra steps, such as login, customer authentication, etc., that are in addition to the primary viewing experience of the streaming media of the esports event. Thus, a favorable live betting experience with esports is elusive.

### SUMMARY

This document describes a system, method and computer-implemented platform for integrating a wagering module with a streaming platform for streamlined and seamless way of allowing users to bet on an esports event while viewing a real-time or live digital video stream of the esports event via the streaming platform. The system, method and platform allow users to make bets on any aspect of the esports event without needing to exit the streaming platform and access an external application or separate website.

This document describes an extension to a video streaming platform, such as a browser, where the extension is configured to allow streamlined odds and betting markets display as well as a streamlined ability to make a wager through a connected provider.

In some aspects, a system for capturing, in real-time, user input related to betting on streaming of electronic sports being played on a streaming media module of a browser-based streaming platform running on a client computer is disclosed. The system includes a betting extension module integrated with a browser that runs on the client computer. The betting extension module is configured to provide an interactive betting user interface that is synchronized, via the browser, with the streaming of the electronic sports being played on the streaming media module of the browser-based streaming platform. The interactive betting user interface provides user interactive interfaces for a user to provide the user input related to the electronic sports. The system further includes a betting platform connected with the browser via a network. The betting platform can be executed on one or more servers connected with the client computer via the network. The betting platform is configured to receive the user input provided to the betting extension and process, in real time, one or more bets from the user input on the electronic sports during the streaming.

Other aspects and implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an Esports betting system, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter;

FIGS. 2A and 2B depict a browser-based video stream with an integrated betting tool, as described herein;

FIG. 3 shows a user interface for a betting tool, in accordance with implementations described herein;

FIG. 4 shows streaming of electronic sports being played on a streaming media module of a browser-based streaming platform running on a client computer, and a browser extension integrated with the browser to improve efficiency of betting on the electronic sports by a viewer.

When practical, similar reference numbers denote similar structures, features, or elements.

### DETAILED DESCRIPTION

This document describes a betting tool, integrated with a video streaming platform that streams an esports event, that provides a streamlined odds and betting markets display, as well as a streamlined ability to make a wager through a connected provider. In some implementations, the tool includes a betting tool as an extension to the video streaming platform, such as a browser.

The extension, and its concomitant experience, is universally usable across multiple browser types and delivery systems, as well as other over-the-top (OTT) channels or broadcast platforms, based on user requirements (Twitch®, for example). Accordingly, the system and betting tool is configured to support multiple OTT experiences. Further, the betting tool extension can be integrated with a social network of users. In this way, the system provides a social betting experience for multiple users that are watching the same esports broadcast streams, to turn previously anonymous betting and matching functionalities that represent a direct Player to Player (P2P) form of betting also called Exchange Betting, which in turn allows a person to request a presently unmatched bet to be matched specifically by a single person (or friend group) within that person's social network, or even the broader user base as a whole.

The betting tool makes it easier for a user, who might be casually watching a stream of an esports event, on their preferred platform, to place a bet on an outcome of that esports event, regardless of platform and without having to divert from the stream. Thus, the betting tool can increase user engagement, with the esports stream as well as with the user's social network at the same time. In some implementations, the betting tool can generate suggested bets to the user, based on live in-game events, or other gamification features of a live stream video of the esports event

In some instances, the betting tool can allow a user to surface or promote an unmatched bet, to be matched by the entire community or portion thereof. Or, the betting tool can surface or promote a bet selection to be matched only by a selected or predetermined user or group, which can be designated by the user/bettor. In other implementations, the betting tool can track and/or generate a bonus users can use for social betting “challenge” matches versus standard “challenge” matches. The bonus can be delivered in terms of less commission or other award associated with the bet.

The betting tool can allow users to set the price amount they want to challenge, or can be configured to suggest a price amount based on historical behavior and/or other analytics of user behavior. Further, the betting tool can create a market for a natural bet delay, accounting for a video stream delay, by synching the betting tool to a time stamp of users' viewing of the esports content.

In some implementations, each user is allocated a digital “wallet,” which is a software-based system and/or application that securely stores users' information, such as payments, accounts, passwords, and betting history. The digital wallet can be used with one or more of a number of mobile or computer-implemented payment systems, to enable electronic debits and credits to a user's account associated with the system. The digital wallet can be integrated with other third-party applications, such as the EST Exchange Platform, Gogawi.com, etc., or be proprietary to a specific streaming service.

The betting tool creates a live market for betting on a real-time, live video stream of an esports event. In some implementations, the betting tool generates simple YES/NO selections, related to what happens next in the esports event. This bet can include a time limit, such as 1 minute, 2 minutes, 5 minutes, or the like. Alternatively, the bet can be nearly instantaneous, based on prompt by the betting tool, such as “is player A about to be killed in this game?”

The betting tool can keep and store a running list of available bets, which can be settled automatically by the betting tool. In some instances, users can be selected via the betting tool for such automatic settlement. In some implementations, the betting tool can allow users to set the odds they want to offer to match the bet, and/or randomly select goods as the stake of the bet. In the latter feature, the betting tool can be integrated with third party wagering platform and applications, including esports specific services like Lootbox®, or other platforms such as Pariplay for internet-based gaming (i.e. “igaming”) experiences. The betting tool can also allow users to play for non-cash awards, such as goods, services, NFTs, etc.

Accordingly, in preferred implementations of the subject matter disclosed herein, a system and method are provided to provide live stream betting, particularly on a specific event being “consumed” (i.e. a live stream being viewed by a user fan/bettor). In some implementations, the system is an extension to a browser application, where the browser application hosts a streaming video service, such as Twitch® or YouTube®, and the extension is synched and connected both with the streaming video service and with a betting platform.

The system further includes an authentication platform that allows users to streamline having to login to multiple accounts and platforms based on where the users are using the extension and betting tool. For initial access, for example, the user is able to access features in an extension, such as a Twitch extension, and be logged in with Twitch ID/Account. Similarly, the user is able to access extension features in their preferred browser and/or operating system, such as Google Chrome®, or using their Google® Account. The betting tool is configured to streamline the login, authentication and betting steps for a customer, given an ability to identify them as an existing customer, or already authenticated with another service.

The user is then able to assign multiple betting accounts or other services to the extension, once logged in, allowing them to view real time relevant data in the extension experience and eventually allowing them to make wagers on potential markets being highlighted or displayed in the extension.

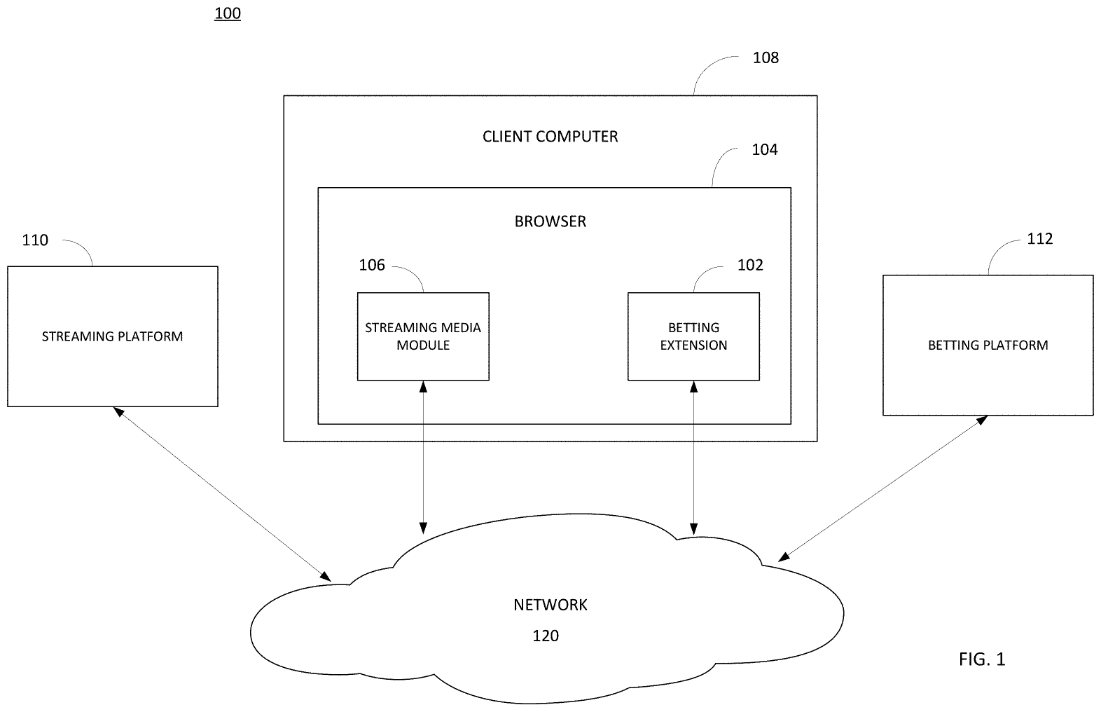

FIG. 1 is a block diagram illustrating an implementation of a system 100 that includes a betting extension 102. The betting extension 102 can be an extension of a browser 104, which is an application running on the system 100 to allow a user to browse the Internet. The browser 104 can host or execute a streaming media module 106 for playing or streaming media such as video and/or audio. The browser 104 is in turn executed on a client computer 108 and displayed in a graphical user interface provided by the client computer 108. The streaming media module 106 can stream video of an esports event, received from a streaming platform 110 via network 120. The network 120 can be the Internet, and the network 120 can include any number of wireless or wired communication mediums that communicate the streaming media from the streaming platform 110 to the streaming media module 106 hosted by the browser 104 on the client computer 108.

The betting extension 102 can by synchronized with the video stream, to seamlessly allow a viewer or user to place a bet, or provide other input, on the outcome of an activity of the esports event. The bet or other input is processed by a betting platform 112, which also communicates with the betting extension 102 via the network 120. Each of the streaming platform 110 and the betting platform 112 can be a server computer, or server component running on a server. In some implementations, the streaming platform 110 and the betting platform can be integrated in or hosted by the same server, or distributed among multiple servers.

In preferred exemplary implementations, the betting extension 102 provides a common user interface (UI)/user experience (UX) regardless of browser 104 or streaming media modul 106 running on the client computer 108. The betting extension 102 can leverage user logon credentials or other account sign-in information used with other services provided by the betting platform 112, which can reduce costs and streamlines the user experience. The betting extension 102 can also be integrated with messaging applications hosted or used by the client computer 108, to integrate betting notifications, alerts or confirmations.

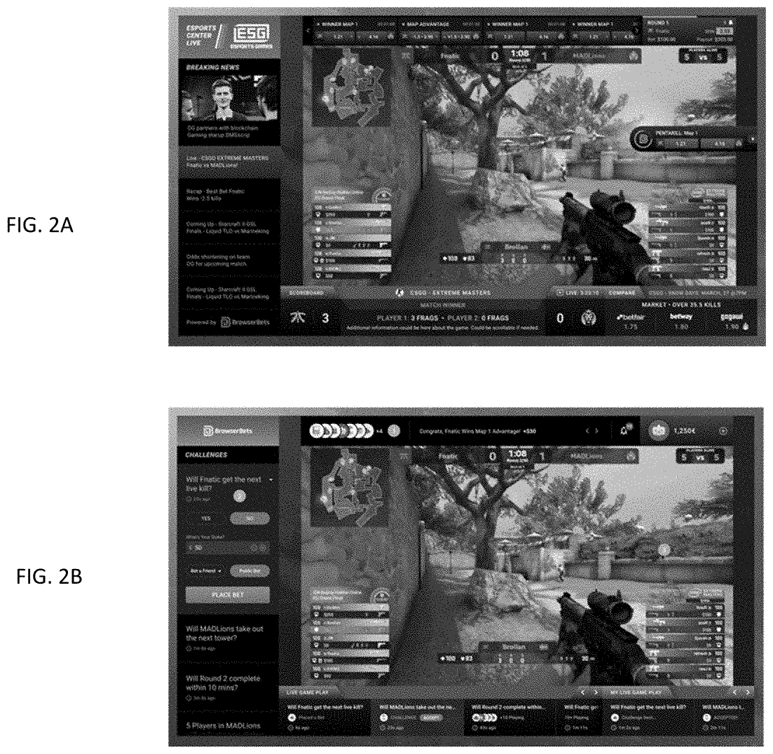

FIG. 2A illustrates a graphical user interface representing a user watching a stream of an esports match in a streaming media module of a browser, with the betting extension installed, and FIG. 2B illustrates the graphical user interface with the betting extension in a “challenge betting” mode. The streaming media module can also be separate from the browser, i.e. a standalone application running on a client computer.

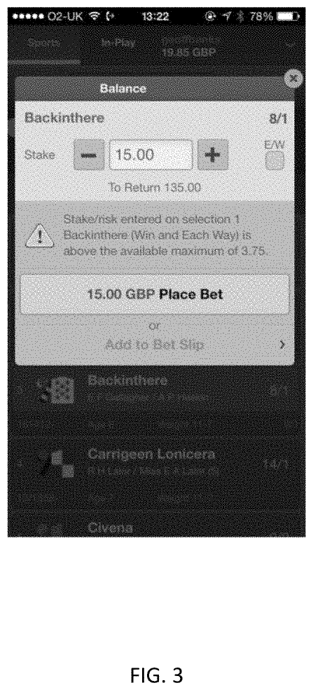

In some implementations, the betting tool or extension can streamline betting offers to users using a link that creates a bet slip on a betting platform such as UltraPay®, which gives a user who is already logged in an ability to bet on a market with two taps, as shown in FIG. 3.

In exemplary implementations, the betting tool can be configured to, without limitation:

1. Show odds and market in Tweet;

2. Show odds and market in other Social Network Posts;

3. Show video or other performance—driving marketing assets on Esports Content Sites;

4. Upsell from Free to Play social games to bet for real money (showcasing markets and prices); and/or

5. Showcase bets in data visualization or live scoreboard apps.

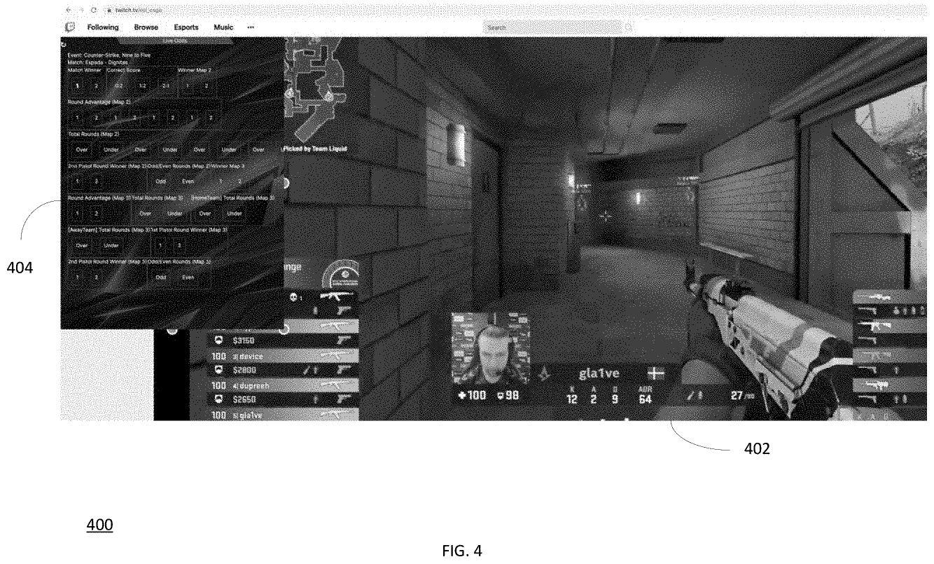

FIG. 4 shows an example UI 400 having a video stream 402 from a streaming media module that streams video of an esports event, and a betting extension 404 that is connected with a betting platform, where the betting extension provides a separate, but integrated, interactive betting UI in which a viewer or user can enter a bet on the outcome of an activity of the streaming esports event. The user can customize the display or the system to display personalized experiences.

The betting extension can provide multiple different views, including, without limitation, a configuration/administration view, a browsing/search mode view, and a broadcast view. The UI of the betting extension can display relevant odds that are generated by the betting platform during a match of an esports event, or about a selected portion of the match. The UI can further display or show a comparison of odds prices for a particular market or match across several sportsbooks. The betting extension allows a user to compile a betting ticket for “deep-link” submission to the betting platform. The betting extension further allows a user to customize alerts, such as thresholds and flags, such as when an outcome occurs or if odds change.

User activity via the betting extension can be captured and processed by the betting platform for backend analytics, business intelligence (BI), artificial intelligence (AI), and other processes that improve the functions of the betting platform and/or betting extension.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system for capturing, in real-time, user input related to betting on streaming of electronic sports being played on a streaming media module of a browser-based streaming platform running on a client computer, the system comprising:
a betting extension module integrated with a browser that runs on the client computer, the betting extension module being configured to provide an interactive betting user interface that is synchronized, via the browser, with the streaming of the electronic sports being played on the streaming media module of the browser-based streaming platform, the interactive betting user interface providing one or more user-interactive interfaces for a user to provide the user input related to the electronic sports; and
a betting platform connected with the browser via a network, the betting platform being configured to receive the user input provided to the betting extension and process, in real time, one or more bets from the user input on the electronic sports during the streaming.

2. The system in accordance with claim 1, wherein the betting extension module generates the interactive betting user interface adjacent to the streaming of the electronic sports in the browser.

3. The system in accordance with claim 1, wherein the betting platform is further configured to transmit, via the network, results of processing the one or more bets to the user.

4. The system in accordance with claim 3, wherein the results of processing the one or more bets are transmitted to the interactive betting user interface of the betting extension module.

5. The system in accordance with claim 1, wherein the interactive betting user interface is configured to display one or more aspects of the electronic sports for users to bet on, and to receive bets from users on the one or more aspects of the electronic sports.

6. The system in accordance with claim 5, wherein the one or more aspects includes odds of an event occurring in the electronic sports.

7. A system for enabling real-time user input related to experiencing and betting on streaming of electronic sports being played on a streaming media module of a browser-based streaming platform running on a client computer, the system comprising:
a programmable processor; and
a non-transitory machine-readable medium storing instructions that, when executed by the processor, cause the at least one programmable processor to perform operations comprising:
running a browser application that hosts the streaming media module of the streaming platform;
executing a betting extension module integrated with the browser, the betting extension module being configured to provide an interactive betting user interface that is synchronized, via the browser, with the streaming of the electronic sports being played on the streaming media module of the browser-based streaming platform, the interactive betting user interface providing one or more user-interactive interfaces for a user to provide the user input related to the electronic sports; and
transmitting, to a betting platform connected with the browser via a network, the user input provided to the betting extension, to process, in real time, one or more bets from the user input on the electronic sports during the streaming.

8. The system in accordance with claim 7, wherein the betting extension module generates the interactive betting user interface adjacent to the streaming of the electronic sports in the browser.

9. The system in accordance with claim 7, wherein the betting platform is further configured to transmit, via the network, results of processing the one or more bets to the user.

10. The system in accordance with claim 9, wherein the results of processing the one or more bets are received by the interactive betting user interface of the betting extension module.

11. The system in accordance with claim 7, wherein operations further include displaying, in the interactive betting user interface, one or more aspects of the electronic sports for users to bet on, and receiving bets from users on the one or more aspects of the electronic sports.

12. The system in accordance with claim 11, wherein the one or more aspects includes odds of an event occurring in the electronic sports.

13. A computer-implemented method of enabling real-time user input related to experiencing and betting on streaming of electronic sports being played on a streaming media module of a browser-based streaming platform running on a client computer, the method comprising:
running a browser application that hosts the streaming media module of the streaming platform;
executing a betting extension module integrated with the browser, the betting extension module being configured to provide an interactive betting user interface that is synchronized, via the browser, with the streaming of the electronic sports being played on the streaming media module of the browser-based streaming platform, the interactive betting user interface providing one or more user-interactive interfaces for a user to provide the user input related to the electronic sports; and
transmitting, to a betting platform connected with the browser via a network, the user input provided to the betting extension, to process, in real time, one or more bets from the user input on the electronic sports during the streaming.

14. The method in accordance with claim 13, wherein the betting extension module generates the interactive betting user interface adjacent to the streaming of the electronic sports in the browser.

15. The method in accordance with claim 13, wherein the betting platform is further configured to transmit, via the network, results of processing the one or more bets to the user.

16. The method in accordance with claim 15, wherein the results of processing the one or more bets are received by the interactive betting user interface of the betting extension module.

17. The method in accordance with claim 16, further include displaying, in the interactive betting user interface, one or more aspects of the electronic sports for users to bet on; and
receiving bets from users on the one or more aspects of the electronic sports.

18. The method in accordance with claim 11, wherein the one or more aspects includes odds of an event occurring in the electronic sports.
